(19) United States
(12) Patent Application Publication
(10) Pub. No.: US 2003/0059572 A1
(43) Pub. Date: Mar. 27, 2003

(54) Heat-transfer laminating unit

(75) Inventors: Masaji Nishikawa, Hachioji-shi (JP); Motoharu Miki, Hachioji-shi (JP); Mineo Hashimoto, Hachioji-shi (JP); Nobuyuki koyama, Hachioji-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Optical Co., Ltd., Tokyo (JP)

(21) Appl. No.: 09/957,848

(22) Filed: Sep. 21, 2001

(51) Int. Cl. B32B 3/10

(52) U.S. Cl. 428/137; 428/194

(57) ABSTRACT

A heat-transfer laminating sheet according to the present invention includes a laminating sheet and a backup sheet both of which are shaped like a cut sheet. The laminating sheet has a separate sheet and a heat-sensitive adhesive resin layer which is provided on the separate sheet and can be separated from the separate sheet. The backup sheet as large as the laminating sheet, at a minimum size, is arranged so as to be opposed to the heat-sensitive adhesive resin layer of the laminating sheet. The laminating sheet and the backup sheet has a bonded part at which they are bonded to each other and a separate part other than the bonded part.

### BACKGROUND OF THE INVENTION

The present invention relates to a laminating unit for protecting a sheet, and more particularly to a heat-transfer laminating unit which can readily cover a cut sheet and be applied to a commercially available laminating apparatus.

### PRIOR ART

In recent years, since an image recording apparatus such as an ink jet printer is highly efficient but inexpensive, it is widely spread. The image recording apparatus can record a highly accurate image on a sheet such as paper. However, an image recorded by the image recording apparatus has poor water resistance and light fastness in comparison with commercial printing, and the image may be soon deteriorated.

Therefore, any protective coating is applied to a sheet on which the image is recorded, in particular purpose. Further, in regard to any conventional printed matter, an image printed on paper or that printed by interior ink such as ink used by magazines must be subjected to protective coating in order to improve various kinds of resistance when it is used in an unexpected environment such as outdoor. In this specification, a sheet, which is a target of protective coating as mentioned above, is referred to as a coating target sheet.

Conventionally, one of the method for applying the protective coating to the coating target sheet, for example, includes to heat-bond laminating films on the both sides of the coating target sheet. The laminating film has a transparent plastic sheet and heat-sensitive adhesive resin applied on the plastic sheet.

The method will now be described hereinafter with reference to FIGS. 41 to 43. FIG. 41 is a cross-sectional view showing a conventional laminating film 1000. FIG. 42 is a view typically showing a process for coating a coating target sheet 4 with the laminating films 1000 shown in FIG. 41 by using a commercial available laminating apparatus. FIG. 43 is a cross-sectional view showing a coating target sheet 4 covered with the laminating films illustrated in FIG. 41.

The prior art laminating film 1000, as shown in FIG. 41, comprises a transparent plastic film 2000 such as polyester or polypropylene, and a heat-sensitive adhesive resin layer 3000 such as ethylene-vinyl acetate copolymer resin applied on the transparent plastic film 2000.

This laminating film 1000 covers the coating target sheet 4 in the following method. For this method, a coating target sheet arrangement process is first carried out. In the coating target sheet arrangement process, two laminating films 1000 sandwiches the coating target sheet 4 to be coated in such a manner that the sheet 4 are opposed to the heat-sensitive adhesive resin layer 3000. Then, as shown in FIG. 42, an insertion process is carried out. In the insertion process, the coating target sheet 4 and the laminating films 1000 are inserted into a laminating apparatus 5000 such as heat rollers. Subsequently, a heat-bonding process is performed. In the heat-bonding process, the inserted laminating films 1000 are heated by the laminating apparatus 5000. Specifically, the two laminating films 1000 are passed between a pair of heated rollers 6000 of the laminating apparatus 5000. Then, the laminating films 1000 are heated during passage, and the heat-sensitive adhesive resin layer 3000 melts by the heat. Thereby the heat-sensitive adhesive resin layer 3000 has the adhesion property. For this, the laminating films 1000 are bonded on the both sides of the coating target sheet 4 by the resin layer 3000. As a result, the transparent plastic films 2000 cover the both sides of the coating target sheet 4. FIG. 43 is a cross-sectional view of the coating target sheet 9000 in the coated state (finished sheet).

The transparent plastic film 2000 usually has a thickness of 100 μm, and a thin one has a thickness of 30 μm. Furthermore, as shown in FIG. 43, a thickness of the finished sheet 9000 in the coated state is twofold or more of that of the transparent plastic film 2000. Therefore, the finished sheet 9000 is thick and hard like a plastic plate.

Therefore, when the flexibility of the coating target sheet 4 is needed even after coating, the laminating film 1000 can not be used.

Moreover, the physical property of the transparent plastic film 2000 may be different from that of the coating target sheet, and the transparent plastic film 2000 may have a large thickness as mentioned above. In such a case, when the finished sheet 9000 is rolled in a cylindrical form, the force in the sliding direction (hereinafter referred to as “sliding stress”) is generated between the transparent plastic film 2000 and the coating target sheet 4. In this case, sliding exfoliation may occur on any boundary face of the transparent plastic film 2000 and the coating target sheet 4, and the transparent plastic film 2000 and the coating target sheet 4 may be peeled off. In case of ink jet print paper in particular, a dedicated ink accepting layer is coated on a base material sheet so as to absorb a large quantity of ink. Therefore, if the sliding stress occurs, the ink jet print paper exfoliates between the base material sheet and the ink accepting layer, because the physical strength of the ink accepting layer is not sufficient, and the bonding force of the base material is not sufficient either.

In order to solve such problems, it is preferable to adopt a heat-transfer laminating method. In this heat-transfer laminating method, a heat-transfer laminating sheet having a heat-sensitive adhesive resin layer on a separate sheet overlaps an image plane of a resin coating target sheet, and these sheets are welded with pressure by heating rollers. When the heat-transfer laminating sheet is attached on the image plane of the resin coating target sheet, the separate sheet is exfoliated. By doing so, only an extremely thin resin layer remains on the image plane of the resin coating target sheet, and this resin layer functions as the coating layer. Thereby this method dissolves the problem in the conventional laminating method for bonding the thick film.

Although the heat-transfer laminating sheet can be applied on only one surface of the resin coating target sheet and used without problem. But the laminating sheet has a new problem involved by this sheet. For example, a cut sheet type heat-transfer laminating sheet is larger than the coating target sheet. The laminating sheet is used in order to securely apply the thin coating layer on the entire surface of the cut sheet type coating target sheet. In this case, the heat-transfer laminating sheet protrudes toward the outside of the coating target sheet when the heat-transfer sheet overlaps the coating target sheet. The protruding part of the heat-transfer laminating sheet reacts to heat generated from the heating rollers. The heat-sensitive adhesive resin layer in the protruding part melts and adheres on the heating rollers. The heat-transfer laminating sheet leads to a problem of fouling of the heating rollers.

### BRIEF SUMMARY OF THE INVENTION

According to the invention, there is provided a heat-transfer laminating unit comprising: a laminating sheet shaped like a cut sheet and comprising a separate sheet and a heat-sensitive adhesive resin layer provided on the separate sheet and configured to be separated from the separate sheet; and

a backup sheet as large as the laminating sheet, at a minimum size, and opposing the heat-sensitive adhesive layer of the laminating sheet. The laminating sheet and the backup sheet are bonded to each other at one part and not bonded at the other part.

According to another aspect of the invention, there is provided a heat-transfer laminating unit comprising: a first laminating sheet comprising a separate sheet and a heat-sensitive adhesive resin layer provided on the separate sheet and configured to be separated from the separate sheet; and

a second laminating sheet of the same structure and substantially the same size as the first laminating sheet, having a heat-sensitive adhesive resin layer which opposes the heat-sensitive adhesive layer of the first laminating sheet.

The first and second laminating sheets are shaped like a cut sheet and have a bonded part at which they are bonded to each other and a separate part other than the bonded part.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a top plan view showing a heat-transfer laminating unit according to a first embodiment;

FIG. 2 is a cross-sectional view of the heat-transfer laminating unit taken along the line X-X in FIG. 1;

FIG. 3 is a top plan view showing the heat-transfer laminating unit when a coating target sheet is arranged;

FIG. 4 is a cross-sectional view showing the heat-transfer laminating unit of FIG. 3 heated by a well-known laminating apparatus;

FIG. 5 is a cross-sectional view showing the state in which a separate sheet is started to peel off from the state illustrated in FIG. 4;

FIG. 6 is a cross-sectional view showing a finished sheet according to the first embodiment;

FIG. 7 is a top plan view showing a modified embodiment of the heat-transfer laminating unit according to the first embodiment;

FIG. 8 is a cross-sectional view showing another modified embodiment of the heat-transfer laminating unit according to the first embodiment;

FIG. 9 is a top plan view showing another modified embodiment of the heat-transfer laminating unit according to the first embodiment;

FIG. 10 is a cross-sectional view showing a heat-transfer laminating unit according to a second embodiment;

FIG. 11 is a cross-sectional view showing a finished sheet according to the second embodiment;

FIG. 12 is a cross-sectional view showing a heat-transfer laminating unit according to a third embodiment;

FIG. 13 is a top plan view showing a heat-transfer laminating unit according to a fourth embodiment;

FIG. 14 is a cross-sectional view of the heat-transfer laminating unit taken along the line X-X in FIG. 13;

FIG. 15 is a cross-sectional view showing the heat-transfer laminating unit of FIG. 13 after a heat bonding process;

FIG. 16 is a top plan view showing the state in which a coating target sheet is interposed in the heat-transfer laminating unit of FIG. 13;

FIG. 17 is a top plan view showing a modified embodiment of the heat-transfer laminating unit according to the fourth embodiment;

FIGS. 17 and 18 are top plan views showing still another embodiment of the heat-transfer laminating unit according to the fourth embodiment;

FIG. 19 is a top plan view showing a heat-transfer laminating unit according to a fifth embodiment;

FIG. 20 is a cross-sectional view showing the heat-transfer laminating unit of FIG. 19 after a heat bonding process;

FIG. 21 is a top plan view showing a heat-transfer laminating unit according to a sixth embodiment;

FIG. 22 is a cross-sectional view showing the heat-transfer laminating unit taken along the line X-X in FIG. 21;

FIG. 23 is a top plan view showing the state in which a coating target sheet is interposed in the heat-transfer laminating unit of FIG. 21;

FIG. 24 is a cross-sectional view showing the heat-transfer laminating unit of FIG. 21 after a heat bonding process;

FIG. 25 is a top plan view showing a modified embodiment of the heat-transfer laminating unit according to the sixth embodiment;

FIG. 26 is a cross-sectional view showing the heat-transfer laminating unit taken along the line X-X in FIG. 25;

FIG. 27 is a top plan view showing a heat-transfer laminating unit according to a seventh embodiment;

FIG. 28 is a cross-sectional view of the heat-transfer laminating unit 71 taken along the line X-X in FIG. 27;

FIG. 29 is a top plan view showing a heat-transfer laminating unit according to an eighth embodiment;

FIG. 30 is a top plan view showing a modified embodiment of the heat-transfer laminating unit according to the eighth embodiment;

FIG. 31 is a top plan view showing another embodiment of the heat-transfer laminating unit according to the eighth embodiment;

FIG. 32 is a top plan view showing a heat-transfer laminating unit according a ninth embodiment;

FIG. 33 is a cross-sectional view showing a heat-transfer laminating unit of FIG. 32 after a heat bonding process;

FIG. 34 is a top plan view showing a modified embodiment of the heat-transfer laminating unit according to the ninth embodiment;

FIG. 35 is a top plan view showing another modified embodiment of the heat-transfer laminating unit according to the ninth embodiment;

FIG. 36 is a top plan view showing a heat-transfer laminating unit according to a tenth embodiment;

FIG. 37 is a cross-sectional view of the heat-transfer laminating unit of FIG. 36 taken along the line X-X in FIG. 36 after a heat bonding process;

FIG. 38 is a top plan view showing a modified embodiment of the heat-transfer laminating unit according to a tenth embodiment;

FIG. 39 is a top plan view showing a heat-transfer laminating unit according an 11th embodiment;

FIG. 40 is a cross-sectional view showing the heat-transfer laminating unit taken along the line X-X in FIG. 39;

FIG. 41 is a cross-sectional view showing a conventional laminating film;

FIG. 42 is a view typically showing a process for coating a coating target sheet 4 with the laminating films in FIG. 41 by using a commercially available laminating apparatus; and

FIG. 43 is a cross-sectional view showing the coating target sheet 4 covered with the laminating films of FIG. 41.

### DETAILED DESCRIPTION OF THE INVENTION

(First Embodiment)

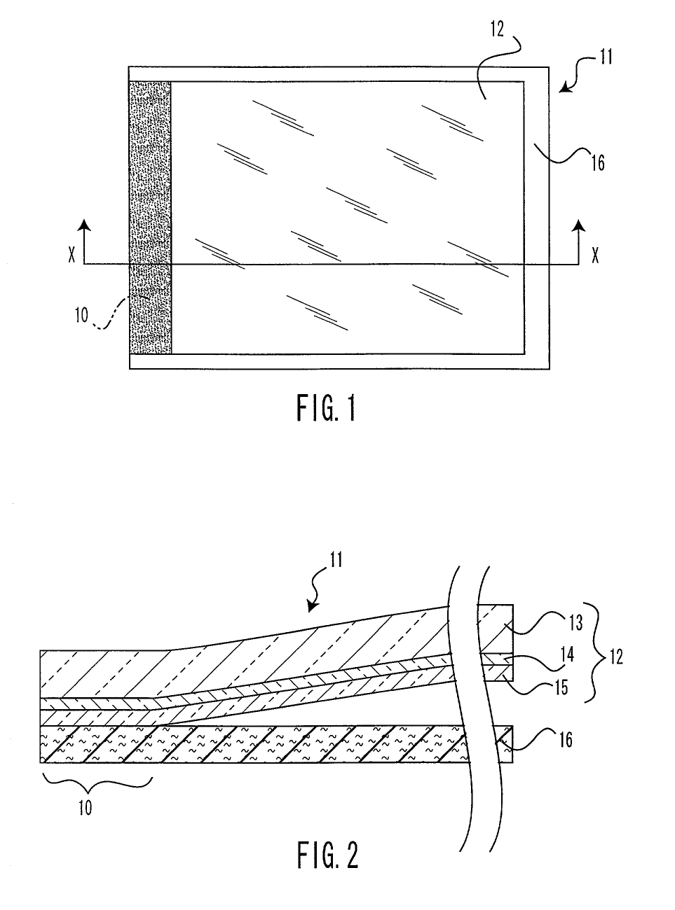

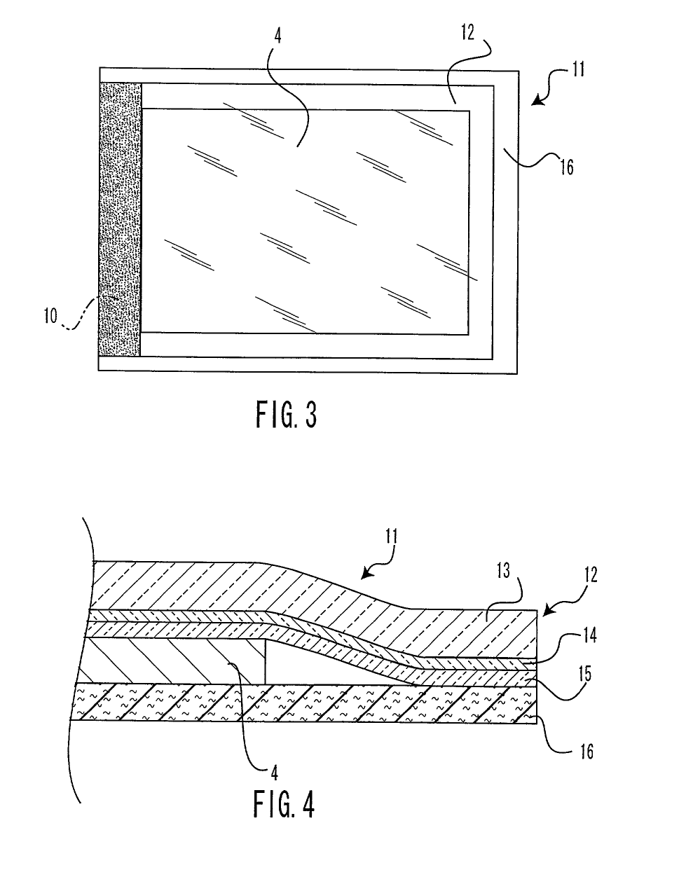

A heat-transfer laminating unit according to a first embodiment of the present invention will now be described hereinafter with reference to FIGS. 1 to 6. FIG. 1 is a top plan view showing a heat-transfer laminating unit 11 according to this embodiment. FIG. 2 is a cross-sectional view showing the heat-transfer laminating unit 11 taken along the line X-X in FIG. 1. FIG. 3 is a top plan view showing the heat-transfer laminating unit 11 when a coating target sheet as a target of coating is arranged. It is to be noted that all figures appended to this specification are schematic diagram so as to support a better understanding for the specification.

As shown in FIG. 1, the heat-transfer laminating unit 11 has a laminating sheet 12 and a backup sheet 16. As shown in FIG. 2, the laminating sheet 12 has a separate sheet 13, an exfoliation layer 14 and a heat-sensitive adhesive resin layer 15.

The separate sheet 13 functions as a base material for supporting the heat-sensitive adhesive resin layer 15. The separate sheet 13 is separated from the heat-sensitive adhesive resin layer 15 after heat transfer of the heat-sensitive adhesive resin layer 15. As a material of the separate sheet 13, various kinds of resin film having the heat resistance, e.g., polyester, polypropylene or nylon are preferable. Also, paper or plastic coating paper is preferable. A thick of the separate sheet 13 is arbitrarily set to a value preferable for handing that an operator can easily grab the separate sheet 13 and the sheet does not wrinkle during the operation. For example, The thickness is approximately 15 μm to 50 μm. But the thickness can be larger than 50 μm. Further, the separate sheet 13 can selectively vary the state of the heat-sensitive adhesive resin layer 13 so that the finished state of the coating target sheet is glossy or matt depending on the surface of the exfoliation layer side which is glossy or matt.

The exfoliation layer 14 is applied on the separate sheet 13 and has the influence for facilitating exfoliation of the heat-sensitive resin layer 15 and the separate sheet 13 as will be described below. As a material of the exfoliation layer 14, there is used well-known wax or silicon, acrylic-based resin, caseinate, or stearic acid. The material of the exfoliation layer 14 is not restricted the above-described materials if variety of alternative material can facilitate exfoliation of the heat-sensitive adhesive resin layer 15 and the separate sheet 13.

The heat-sensitive adhesive resin layer 15 is provided on the surface of the separate sheet 13 through the exfoliation layer 14. The heat-sensitive adhesive resin layer 15 is transparent and colorless, and has the water resistance. Furthermore, the heat-sensitive adhesive resin layer 15 becomes soft or molten when heated to, for example, 80 to 200° C., and has resin which is bonded with a contacting part when the temperature drops. As this kind of resin, a hot-melt adhesive is well known in the art. As a typical example, ethylene-vinyl acetate-based, ethylene acrylic acid-based, polyamide-based, polyolefin-based, urethane-based, or poly vinyl acetate-based resin can be preferably applied. The hot-melt adhesive has the excellent water resistance. Moreover, a temperature for softening or melting down the heat-sensitive adhesive resin layer 15 is not restricted to the above-described temperature, and any temperature can be arbitrarily selected as long as the surface of the coating target sheet is softened at an ordinary temperature and does not adhere to the circumferences.

In addition, the heat-sensitive adhesive resin layer 15 is configured to be thinner than the separate sheet 13. For example, the heat-sensitive adhesive resin layer 15 has a thickness of approximately 1 μm to 10 μm.

As shown in FIG. 1, the laminating sheet 12 is cut into a rectangular shape and has a shape like a so-called cut sheet. The shape of the laminating sheet 12 is equal to or larger than that of the coating target sheet 4 which is a sheet to be coated (it is larger in this embodiment). It is to be noted that the coating target sheet 4 is a sheet that is protectively coated by the heat-transfer laminating unit 11. A picture is formed on the surface of the coating target sheet 4 by, e.g., an ink jet printer. Additionally, if a part of the coating target sheet 4 is coated, the laminating sheet 12 also can be formed smaller than the coating target sheet 4.

The laminating sheet 12 is heated by a well-known laminating apparatus and transfers the heat-sensitive adhesive resin layer 15 onto the coating target sheet 4. In this specification, the laminating sheet 12 is heated by the laminating apparatus 5000 shown in FIG. 42 used in the prior art.

A backup sheet 16 has a shape which is substantially the same as the laminating sheet 12 or slightly larger so as to cover the laminating sheet 12. The backup sheet 16 has a dimension larger than that of the laminating sheet 12 in this embodiment. Although various kinds of material can be applied for the backup sheet 16, a sheet that does not have the adhesive property is used in the back up sheet 16. Since the backup sheet 16 is thrown out after heat transfer, an inexpensive material, particularly paper is effective. A role of the backup sheet 16 is to prevent the laminating apparatus 5000 from being fouled by accepting the heat-sensitive adhesive resin layer 15 which is out of a coating target of the coating target sheet 4 and is molten and softened during heat transfer. In particular, the backup sheet 16 prevents the molten heat-sensitive adhesive resin layer 15 from adhering on the roller surfaces of a pair of rollers 6000. Further, another role of the backup sheet 16 is to maintain the coating target sheet 4 in cooperation with the laminating sheet 12.

Furthermore, the laminating sheet 12 and the backup sheet 16 are bonded and integrated with each other at one portion as indicated by reference numeral 10. In this specification, both the bonded portion of the laminating sheet 12 and the backup sheet 16 will be referred to as a bonded part and any other portion of the same will be referred to as a separated part.

It is to be noted that, the laminating sheet 12 and the backup sheet 16 are bonded to each other at one end along the longitudinal direction of the backup sheet 16 in this embodiment. An easiest method for realizing this integration is a method for superimposing the backup sheet 16 on the laminating sheet 12 and heating and bonding them. That is to say, a part of the heat-sensitive adhesive resin layer 15 provided on the laminating sheet 12 is heated, and this layer is bonded to the backup sheet 16. In this case, although the layer is exfoliated when strongly peeled because of existence of the exfoliation layer 14, a characteristic of the exfoliation layer 14 may be adjusted so as to provide the practical strength when the layer is not forcibly peeled off.

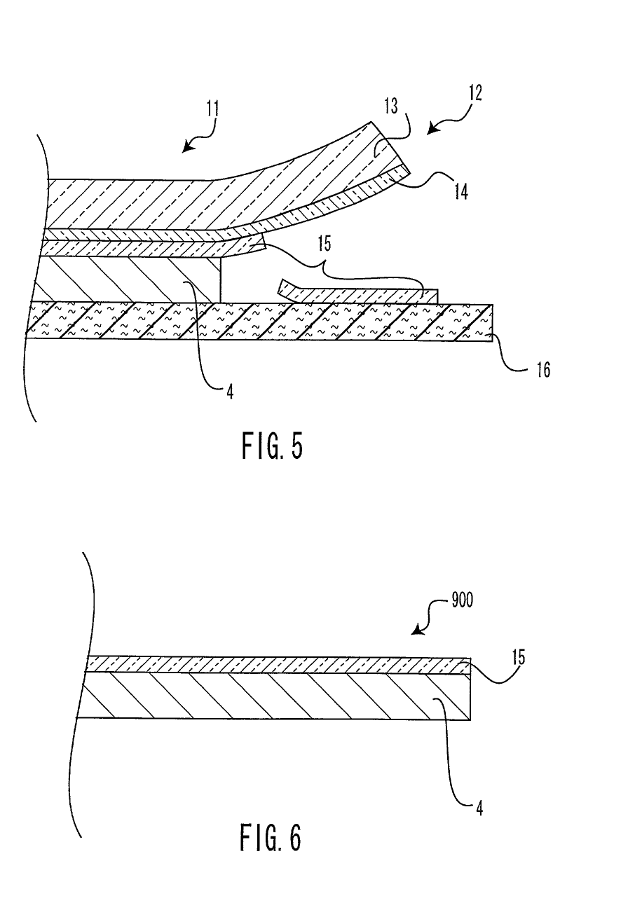

Description will now be given as to a process for coating the coating target sheet 4 with the heat transfer laminating unit 11 having the above-described structure with reference to FIGS. 4 to 6. FIG. 4 is a cross-sectional view showing the heat-transfer laminating unit 11 heated by a well-known laminating apparatus when the coating target sheet 4 is arranged. FIG. 5 is a cross-sectional view showing the state that the separate sheet 13 is started to peel off from the state depicted in FIG. 4. FIG. 6 is a cross-sectional view showing the coating target sheet 900 (which will be referred to as a finished sheet hereinafter) after the separate sheet 13 and the backup sheet 16 are removed, and the heat-sensitive adhesive resin layer 15 as a protection layer is transferred and applied onto the coating target sheet 4.

A coating target sheet arrangement process is first carried out in the heat-transfer laminating unit 11 in order to cover the coating target sheet 4. The coating target sheet arrangement process is a process for arranging the coating target sheet 4 in the heat-transfer laminating unit 11. Particularly, in this process, the coating target sheet 4 is inserted into a gap between the laminating sheet 12 and the backup sheet 16. That is, the coating target sheet 4 is interposed between the laminating sheet 12 and the backup sheet. To insert the coating target sheet 4, the laminating sheet 12 is raised and opened around the part bonded to the backup sheet 16. That is to say, the laminating sheet 12 is curled up so as to widen a gap with respect to the separated part of the backup sheet 16. With the laminated sheet 12 being curled up in this manner, the coating target sheet 4 is arranged between the laminating sheet 12 and the backup sheet. At this moment, the coating target sheet 4 is arranged in such a manner that its surface having an image being recorded thereon, i.e., its surface as a target of coating, is opposed to the heat-sensitive adhesive resin layer 15 of the laminating sheet 12.

The heat-sensitive adhesive resin layer 15 is formed thin as illustrated in the above-described structure in the heat-transfer laminating unit 11. Furthermore, the heat-sensitive adhesive resin layer 15 is arranged on the separate sheet 13 having a thickness such that an operator can easily grab. Because of these members, the coating target sheet 4 can be arranged so as to be opposed to the heat-sensitive adhesive resin layer 15, and a position of the coating target layer 4 can be relatively easily adjusted with respect to the thin heat-sensitive adhesive resin layer 15 in this coating target sheet arrangement process.

Subsequently, an insertion process for inserting the heat-transfer laminating unit 11 into the laminating apparatus 5000 is carried out. The coating target sheet 4 has been arranged in heat-transfer laminating unit 11. In this process, the coating target sheet 4 is interposed between the laminating sheet 12 and the backup sheet 16, and both have such a thickness that an operator can easily grab them. Therefore, the heat-transfer laminating unit 11 can be likewise easily inserted into the laminating apparatus 5000.

Then, a heat bonding process is performed. In this heat bonding process, the inserted heat transfer laminating unit 11 is heated by the laminating apparatus 5000. Entering into the details, the heat-transfer laminating unit 11 is passed between a pair of the heated rollers 6000 of the laminating apparatus 5000. The heat-transfer laminating unit 11 is heated by a pair of the rollers 6000 during this passage. The heat-sensitive adhesive resin layer 15 is molten by this heat. The molten heat-sensitive adhesive resin layer 15 covers the coating target plane of the coating target sheet 4. Thereafter, the heat-transfer laminating unit 11 is sequentially fed out from the laminating apparatus 5000, and a temperature of the heat-sensitive adhesive resin layer 15 drops. Furthermore, the heat-sensitive adhesive resin layer 15 adheres on the coating target sheet 4 and is bonded to the coating target sheet 4 and the backup sheet 16 (Refer to the FIG. 4).

After the heat-transfer laminating unit 11 is completely fed out from the laminating apparatus 5000, the separate sheet 13 is peeled off (Refer to the FIG. 5). Incidentally, since the laminating sheet 12 has the exfoliation layer 14, the separate sheet 13 can be peeled off, as different from the heat-sensitive adhesive resin layer 15 bonded to the coating target sheet 4.

As a result, as shown in FIG. 6, the heat-transfer adhesive resin layer 15 is transferred onto the coating target sheet 4 and protects the printed plane of the coating target sheet 4. That is to say, the heat-sensitive adhesive resin layer 15 functions as a protective coat of the coating target sheet 4.

In this heat-transfer laminating unit 11, as described above, has the laminating sheet 12. In the laminating sheet 12, the heat-sensitive adhesive resin layer 15 is held by the separate sheet 13 thicker than the heat-sensitive adhesive resin layer 15. Moreover, the backup sheet 16 is set so as to be thick as similar to the separate sheet 13. In addition, the laminating sheet 12 and the backup sheet 16 are bonded to each other at one end. Therefore, even if the thickness of the heat-sensitive adhesive resin layer 15 as the protective coat is extremely thin as, e.g., 1 μm to 10 μm, the heat-transfer laminating unit 11 can be easily interposed between the laminating sheet 12 and the backup sheet 16. In addition, since the heat-transfer laminating unit 11 can be inserted into the laminating apparatus 5000 with the coating target sheet 4 being interposed as described above, handling in each process has no problem and the heat-transfer laminating operation can be excellently carried out.

Additionally, the heat-transfer laminating unit 11 can suppress increase in the thickness of the finished sheet 900 to a very small range as mentioned above. Therefore, the heat-transfer laminating unit 11 can suppress changes in appearance and flexibility of the coating target sheet 4 to a small amount even after coating.

Further, the finished sheet 900 includes the thin and flexible heat-sensitive adhesive resin layer. Even if the finished sheet 900 is rolled in the cylindrical form, the sliding stress acting between the heat-sensitive adhesive resin layer 15 and the coating target sheet 4 is small. Therefore, even if various kinds of load are applied to the heat-transfer laminating unit 11, it is possible to form the finished sheet 900 in which an accident, such as exfoliation of the coating or damages to the coating target sheet, will scarcely occur or not occur at all.

Furthermore, the part of the heat-sensitive adhesive resin layer 15, which is not opposed to the coating target sheet 4, is bonded to the backup sheet 16. Thus, the heat-sensitive adhesive resin layer 15 is prevented from adhering to a pair of the rollers 6000 of the laminating apparatus 5000. Accordingly, this heat-transfer laminating unit 11 can also prevent the laminating apparatus 5000 from being fouled.

The heat-sensitive adhesive resin layer 15 has been described as a single layer. Even if the heat-sensitive adhesive resin layer is a single layer, the excellent surface protection effect can be securely obtained. However, when the stronger protection effect is needed, another transparent resin coating layer can be interposed between the exfoliation layer 14 and the heat-transfer adhesive resin layer 15. It is preferable that this resin layer also has thermoplastic resin. In particular, it is preferable that the resin layer has ethylene-vinyl acetate copolymer, polyolefin, poly vinyl chloride, polyurethane or the like.

In the heat-transfer laminating unit 11 according to this embodiment, even if a thickness of the transfer coating layer made up of the heat-sensitive adhesive resin layer 15 and a coating layer configured to thermoplastic resin superimposed on this heat-sensitive adhesive resin layer 15 is set to an extremely thin, e.g., several μm to ten-odd μm, the heat bonding process can be performed without troubles as the single layer mentioned above. The heat transfer operation can be therefore excellently carried out.

Moreover, as described above, the heat-sensitive adhesive resin layer 15 has a basic protection action and effect such as improvement in water resistance of the surface of the coating target sheet 4, and improvement in the physical strength or the like. In addition, the heat-sensitive adhesive resin layer 15 can suppress optical scatter on the surface of the coating target sheet 4 to be coated, and the excellent visual recognition property of a picture can be obtained.

Additionally, the heat-sensitive adhesive resin layer 15 can obtained special action and effect by mixing an addition agent having a special function into resin of itself. For example, the color fastness to light of a picture can be improved by adding an ultraviolet absorber. Further, the heat-sensitive adhesive resin layer 15 can suppress adhesion of dust on the surface of the finished sheet 900 by mixing an addition agent for lowering the electrical resistance. Furthermore, the heat-sensitive adhesive resin layer 15 can obtain the anti-bacterial/mildewproof effect with respect to the surface of the finished sheet 900 by mixing an addition agent having the anti-bacterial activity and the mildew resistance.

Incidentally, in this embodiment, although the laminating sheet 12 and the backup sheet 16 are heated and bonded to each other at their one part, they may be bonded by applying pressure besides heat bonding. For example, a double-coated tape may be used or a pressure-sensitive adhesion may be used. Moreover, the bonded part 10 can be bonded by a bonding member. Bonding mentioned above is carried out by using, e.g., a stapler or sewing using a thread.

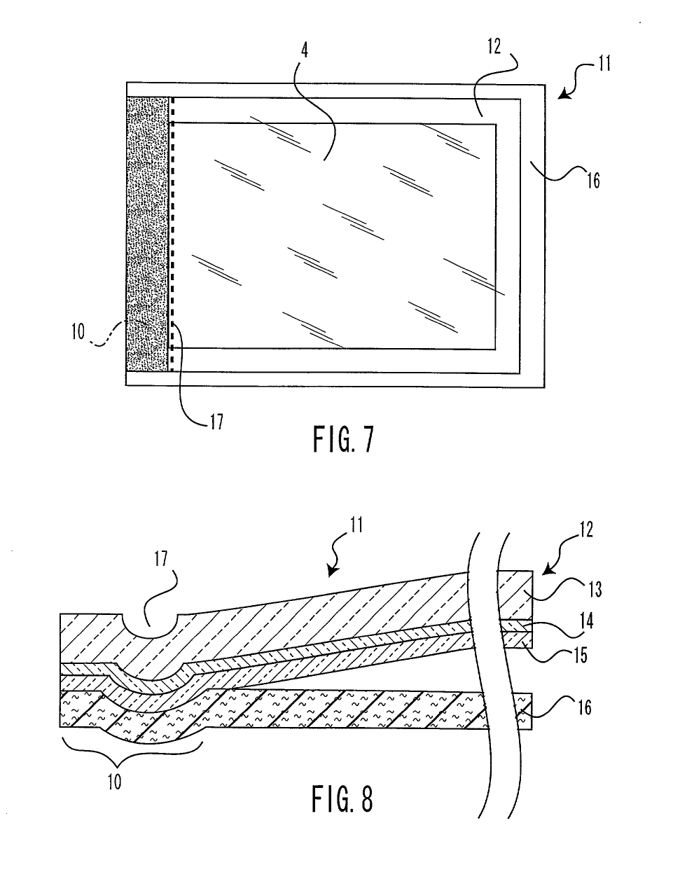

Incidentally, in the coating target sheet arrangement process, when raising the laminating sheet 12 as described above, a bend line for facilitating bend of the laminating sheet 12 may be provided in order to prevent unnecessary force (for example, stress) from being applied to the bonded part 10. The bend line means an auxiliary line for facilitating bend of a sheet type material such as a fold line, a cut line or a pressure line. For example, the bend line 17 is a perforated line formed on the border between the bonded part 10 and the separated part with respect to the backup sheet 16 on the laminating sheet 12 as shown in FIG. 7. If the laminating sheet 12 has the bend line 17 which is the perforated line, the laminating sheet 12 can be easily bent along the perforated line, and the stress is hardly applied to the bonded part 10.

Therefore, the laminating sheet 12 performs an advantage that it is hardly peeled off from the backup sheet 16.

In addition, as shown in FIG. 8, the bend line 17 may be not only the perforated line but also a groove formed on the border between the bonded part 10 and the separated part with respect to the backup sheet by the embossing processing. That is, the bend line 17 is not restricted in the structure as long as it is arranged on the border between the bonded part 10 and the separated part and facilitates bend of the laminating sheet 12. Additionally, the bend line 17 can be provided to the backup sheet 16 in place of the laminating sheet 12. In this case, when the coating target sheet 4 is interposed in the heat-transfer laminating unit 11, the backup sheet 16 is operated so as to be raised.

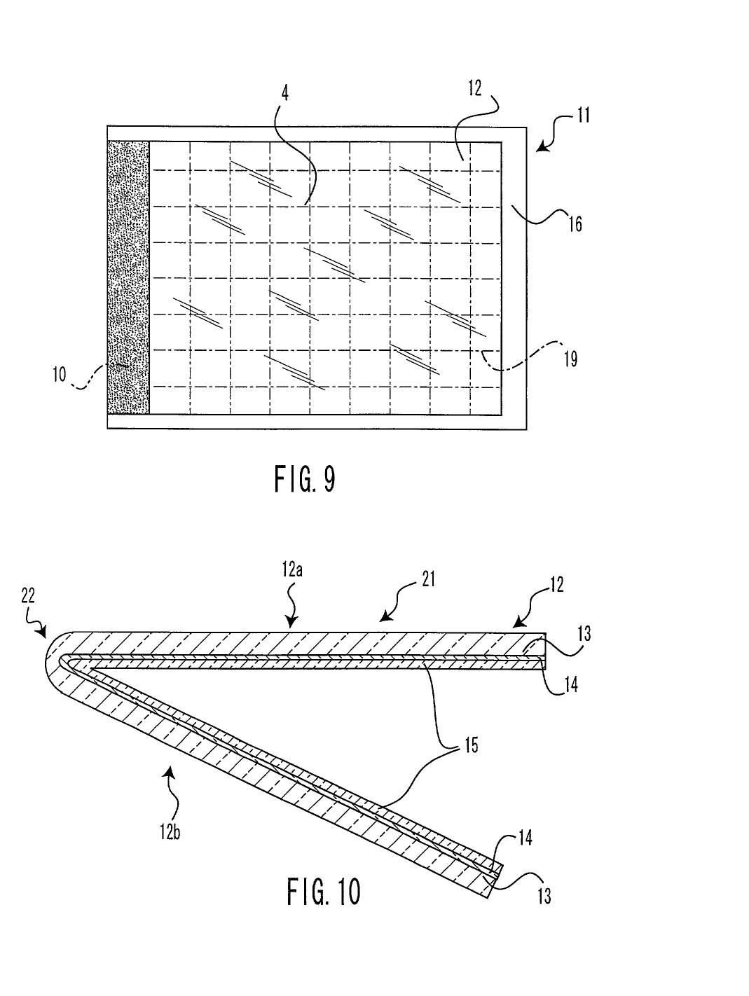

Further, the backup sheet 16 according to this embodiment can have a lattice index 19 on the plane opposed to the laminating sheet 12, as shown in FIG. 9. When the backup sheet 16 has the index 19, the coating target sheet 4 can be positioned with the index 19 being used as a reference. Therefore, the coating target sheet 4 can be further securely positioned with respect to the backup sheet 16. Incidentally, although the index 19 is formed into a lattice shape in FIG. 9, the index 19 may take any form such as a plurality of crisscrosses, a plurality of parallel lines, an arbitrary curve or the like. The index 19 is not restricted to the above example if it can help arrangement of the coating target sheet 4. Furthermore, the index 19 may indicate a region that can be coated with the laminating sheet 12. Moreover, although the index 19 is arranged on the backup sheet 16, it may be arranged on the laminating sheet 12.

(Second Embodiment)

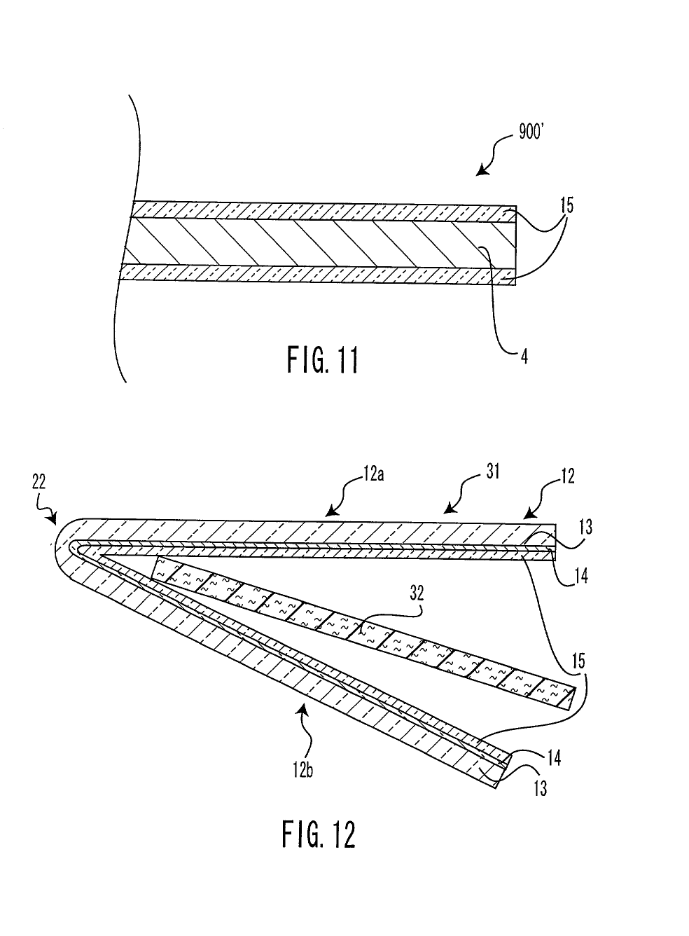

A second embodiment according to the present invention will now be described with reference to FIGS. 10 and 11. Incidentally, in this embodiment, reference numerals denoting the same constituent members of the heat-transfer laminating unit are used to designate the same constituent members of the heat-transfer laminating unit 11 according to the firs embodiment of the present invention, thereby omitting the detailed explanation.

As different from the heat-transfer laminating unit 11 according to the first embodiment, the heat-transfer laminating unit 21 according to this embodiment does not have the backup sheet 16. Specifically, the heat-transfer laminating unit 21 is configured to bending one laminating sheet 12 so as to be opposed to the heat-sensitive adhesive resin layer 15. Incidentally, as shown in FIG. 10, the laminating sheet 12 is divided into a first laminating sheet 12a and a second laminating sheet 12b with the bend portion denoted by reference numeral 22 as a boundary. In other words, the bend portion 22 is a bonded part at which the first laminating sheet 12a and the second laminating sheet 12b are bonded to each other. When considering in this way, since the first and second laminating sheets are not bonded to each other at any part other than the bonded part, it can be said that a region other than the bonded part is a separated part.

The laminating sheet 12 is bent in such a manner that the first laminating sheet 12a and the second laminating sheet 12b can have the same dimension and shape.

Description will now be given as to a process for covering the coating target sheet 4 with the heat-transfer laminating unit 21 having the above-described structure. The process according to this embodiment is different from the process according to the first embodiment in only the coating target sheet arrangement process. In the coating target sheet arrangement process according to this embodiment, the coating target sheet 4 is arranged between the first laminating sheet 12a and the second laminating sheet 12b.

As illustrated in the above structure, since the heat-sensitive adhesive resin layer 15 of the first laminating sheet 12a is arranged so as to be opposed to that of the second laminating sheet 12b, both sides of the coating target sheet 4 can be covered with the heat-sensitive adhesive resin layer 15. The separate sheet 13 can be exfoliated after coating as similar to the first embodiment. Therefore, although the both sides of the heat-transfer laminating unit 21 according to this embodiment can be coated, this heat-transfer laminating unit 21 can obtained the coating effect similar to that of the heat-transfer laminating unit 11 according to the first embodiment. FIG. 11 shows a finished sheet 900′ having the both sides of the coating target sheet 4 being covered with the heat-sensitive adhesive resin layer 15. The finished sheet 900′ is covered with the heat-sensitive adhesive resin layer 15 having the water resistance on the both sides thereof. Therefore the finished sheet 900′ is prominently increased the water resistance and is preferable for obtaining a poster, a drawing, a map or the like used in the open air.

(Third Embodiment)

A third embodiment according to the present invention will now be described with reference to FIG. 12. In this embodiment, the same constituent members as those in the heat-transfer laminating unit 21 according to the second embodiment of the present invention mentioned above are denoted by reference numerals used for designating the same constituent members of this heat-transfer laminating unit 21, thereby omitting the detailed explanation.

As shown in FIG. 12, the heat-transfer laminating unit 31 according to this embodiment is characterized in that an intervened sheet 32 is removably interposed in the laminating sheet 12 which is bent as similar to the second embodiment.

The intervened sheet 32 is configured to a material which has no adhesiveness by itself, for example, a material similar to that of the backup sheet 16 according to the first embodiment. It is desirable that the intervened sheet 32 has the dimension equal to or slightly larger than those of the first and second laminating sheets 12a and 12b.

When the heat-transfer laminating unit 31 according to this embodiment is used with the intervened sheet 32 being sandwiched therein, this heat-transfer laminating unit 31 can be used for coating one side. Further, when the heat-transfer laminating unit 31 is used with the intervened sheet 32 being removed, it can be utilized for coating the both sides. In this manner, the heat-transfer laminating unit 31 can cope with the both use applications, i.e., single-side coating and double-side coating. Furthermore, when the coating target sheets are arranged on a front surface and a back surface of the intervened sheet 32, the heat-transfer laminating unit 31 can carry out single-side coating with respect to two coating target sheets in one heat bonding process.

Moreover, the heat-transfer laminating unit 31 can effectively prevent accidents that the opposed heat-sensitive adhesive resin layers 15 are naturally melted and bonded to each other during storage from occurring.

Since the intervened sheet 32 is used for only the purpose of preventing bonding, an inexpensive material such as paper is preferable for the intervened sheet 32 in the light of cost. In case of attaching a high value to a function of preventing natural melting, use of a paper material to which non-adhesive processing is applied is further preferable as a material of the intervened sheet 32.

In FIG. 12, the intervened sheet 32 is constituted separately from the laminating sheet 12 and just arranged between the first and second laminating sheets 12. However, the intervened sheet 32 may have one end intervened in the vicinity of the bent part 12 and bonded to the laminating sheet 12. In addition, when the intervened sheet 32 is integrally formed with the laminating sheet 12, a perforated line, a cut line or the like may be formed on the border between the bonded part and the separated part thereof. In this case, the intervened sheet 32 can selectively take the state in which it is fixed to the laminating sheet 12 and that it is separated from the laminating sheet 12.

(Fourth Embodiment)

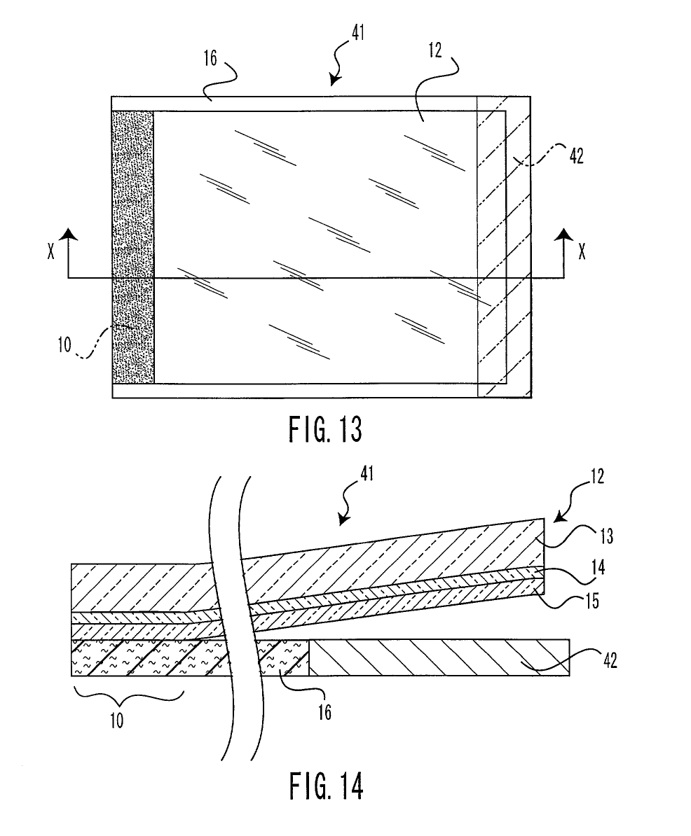

A fourth embodiment according to the present invention will now be described with reference to FIGS. 13 and 14. In this embodiment, the same constituent members as those of the heat-transfer laminating unit 11 according to the first embodiment of the present invention mentioned above are denoted by reference numerals designating the same constituent members of this heat-transfer laminating unit 11, thereby omitting the detailed explanation.

FIG. 13 is a top plan view of a heat-transfer laminating unit 41 according to this embodiment. FIG. 14 is a cross-sectional view showing the heat-transfer laminating unit 41 taken along the line X-X in FIG. 13.

As different from the heat-transfer laminating unit 11 according to the first embodiment, the heat-transfer laminating unit 41 according to this embodiment has a non-bonded part at which the heat-sensitive adhesive resin layer 15 and the backup sheet 16 are not bonded to each other after the heat bonding process on the periphery of the end portion other than the vicinity of the bonded part 10 of the backup sheet 16. In particular, in the heat-transfer laminating unit 41, the non-bonded part is a nonbonding processed part 42 which is an region on the backup sheet 16 to which non-bonding processing is applied. The non-bonding processed part 42 will be described in detail hereinafter.

As shown in FIG. 13, the non-bonding processed part 42 is arranged on the periphery of the end portion on the side opposed to the bonded part 10 of the backup sheet 16. Further, the non-bonding processed part 42 is formed so as to be positioned on the inner side away from the edge of the laminating sheet 12 so that it can be opposed to a part of the laminating sheet 12.

In the non-bonding processed part 42, non-bonding processing such as wax processing or silicon processing is applied to the backup sheet 16 so as to have the low surface energy. Even if the heat-transfer laminating unit 41 is heated in the heat bonding process, the region of the heat-sensitive adhesive resin layer 15 opposed to the non-bonding processed part 42 is very weakly bonded to or is not completely bonded to the non-bonding processed part 42.

Since the heat-transfer laminating unit 41 according to this embodiment has the non-bonding processed part 42 which is the non-bonded part, a part 43 is formed as shown in FIG. 15. In the part, the laminating sheet 12 and the backup sheet 16 are not bonded to each other even after the heat bonding process. The part 43 where nothing is bonded can be a trigger (part at which the separate sheet be easily grabbed) for readily exfoliating the separate sheet 13 and the backup sheet 16.

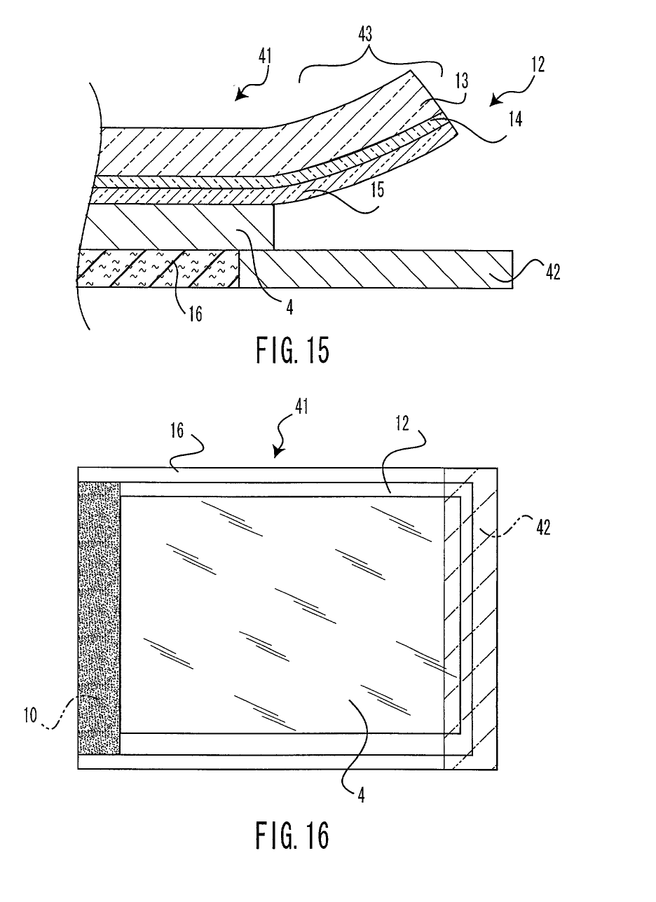

Incidentally, as shown in FIG. 16, if the laminating sheet 12 is configured to be larger than the coating target sheet 4, the separate sheet 13 and the backup sheet 16 are strongly bonded to each other. However, since the heat-transfer laminating unit 41 according to this embodiment has the non-bonding processed part 42, even if the above-described both sheets are strongly bonded to each other, the separate sheet 13 can be easily exfoliated after transferring the heat-sensitive adhesive resin layer to the coating target sheet.

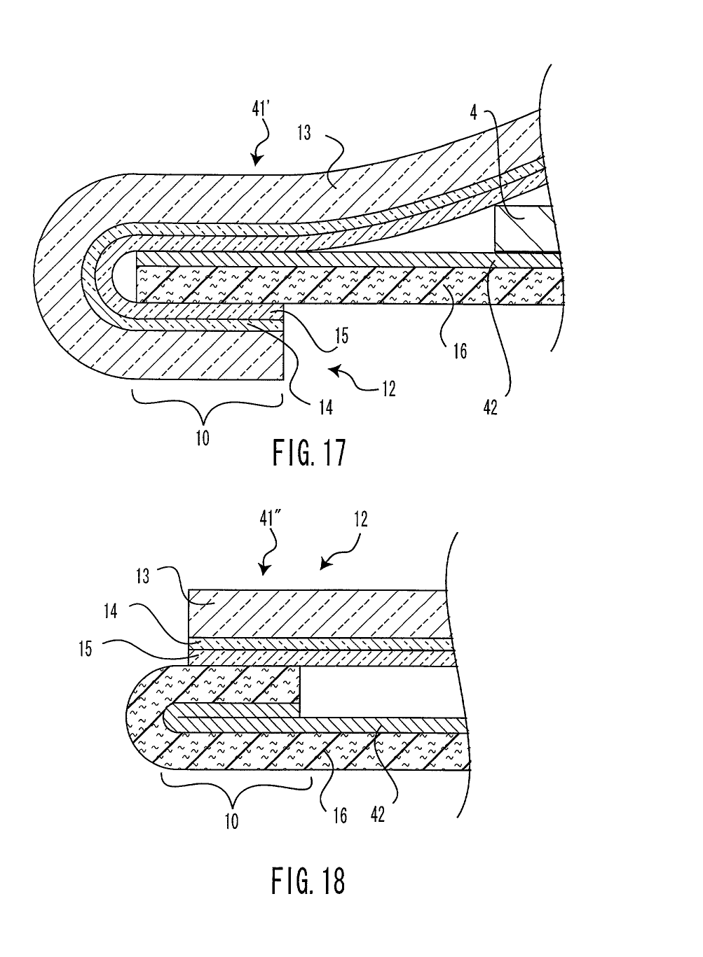

Incidentally, in the heat-transfer laminating unit 41, the non-bonding processed part 42 is arranged only on the periphery of the end portion on the opposite side to the bonded part 10 of the backup sheet 16, the non-bonding processed part 42 can be arranged on the entire surface on which the backup sheet 16 is brought into contact with the coating target sheet 4. In this case, it is difficult to bond the laminating sheet 12 on the surface of backup sheet 16 to contact with the coating target sheet 4 by heat bonding as the heat-transfer laminating unit 41 illustrated in FIG. 13. Therefore, as similar to the heat-transfer laminating unit 41′ shown in FIG. 17, the end portion of the laminating sheet 12 is heated and bonded on a surface where the non-bonding processed part 42 of the backup sheet 16 is not arranged, and the bonded part 10 is formed. Then, the separated part of the laminating sheet 12 which is a portion other than the bonded part 10 is bent so as to be opposed to the non-bonding processed part 42.

Since the heat-transfer laminating unit 41′ having the above-described structure has the non-bonding processed part 42 over the entire surface where it is opposed to the coating target sheet 4, the separate sheet 13 can be easily exfoliated after transferring the heat-sensitive adhesive resin layer.

Furthermore, as shown in FIG. 18, the laminating sheet 12 can be bonded to the backup sheet 16 having the non-bonding processed part 42 over the entire surface where it is brought into contact with the coating target sheet 4 as mentioned above. Specifically, as shown in FIG. 18, the backup sheet 16 can be bent at the end portion thereof so that the non-bonding processed part 42 is appressed against the backup sheet 16, and the reversed surface (surface on which the non-bonding processed part 42 is not provided) and the laminating sheet 12 can be bonded to each other.

Moreover, the non-bonding processed part 42 according to this embodiment is not restricted to specific arrangements as long as the non-bonding processed part 42 can be a trigger for easily exfoliating the separate sheet 13 and the backup sheet 16. That is, it suffices to arrange the non-bonding processed part 42 at least at one part of the end portion of the backup sheet 16.

(Fifth Embodiment)

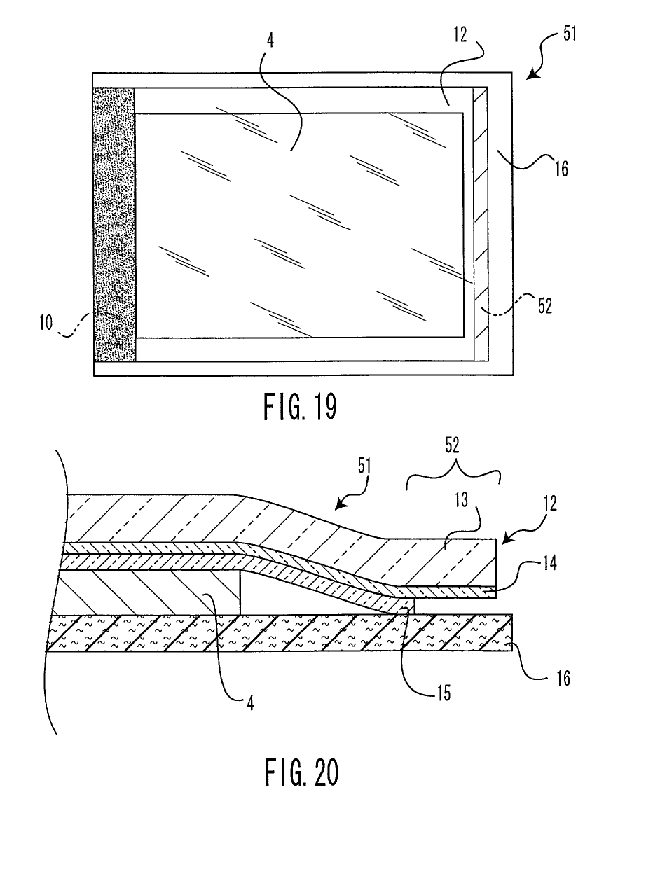

A fifth embodiment according to the present invention will now be described with reference to FIG. 19. In this embodiment, the same constituent members as those of the heat-transfer laminating unit 41 according to the fourth embodiment according to the present invention mentioned above are denoted by reference numerals designating the same constituent members of this heat-transfer laminating unit 41, thereby omitting the detailed explanation. FIG. 19 is a top plan view showing the heat-transfer laminating unit 51 according to this embodiment.

The heat-transfer laminating unit 51 according to this embodiment is different from that of the fourth embodiment in the structure of the non-bonded part. The non-bonded part of this embodiment is provided to the laminating sheet 12. Specifically, the non-bonded part is an region 52 which is on the opposite side to the bonded part 10 and which does not have the heat-sensitive adhesive resin layer 15 of the end portion at a position which is not opposed to the coating target sheet 4 in the laminating sheet 12.

According to this structure, in this heat-transfer laminating unit 51, as shown in FIG. 20, the region 52 having no heat-sensitive adhesive resin layer 15 is not bonded to the backup sheet 16 even after the heat bonding process. Therefore, the region 52 can be a trigger for easily exfoliating the separate sheet 13 and the backup sheet 16. Thus, the heat-transfer laminating unit 51 can easily exfoliate the separate sheet 13 after transferring the heat-sensitive adhesive resin layer 15 with respect to the coating target sheet.

The region 52 may lie at the corner of the separated part side of the laminating sheet 12, alternatively, the region 52 may lie at any other portion if it can be a trigger for easily exfoliating the separate sheet 13 and the backup sheet 16. It suffices to arrange the region 52 at least at a part of the end portion of the backup sheet 16.

(Sixth Embodiment)

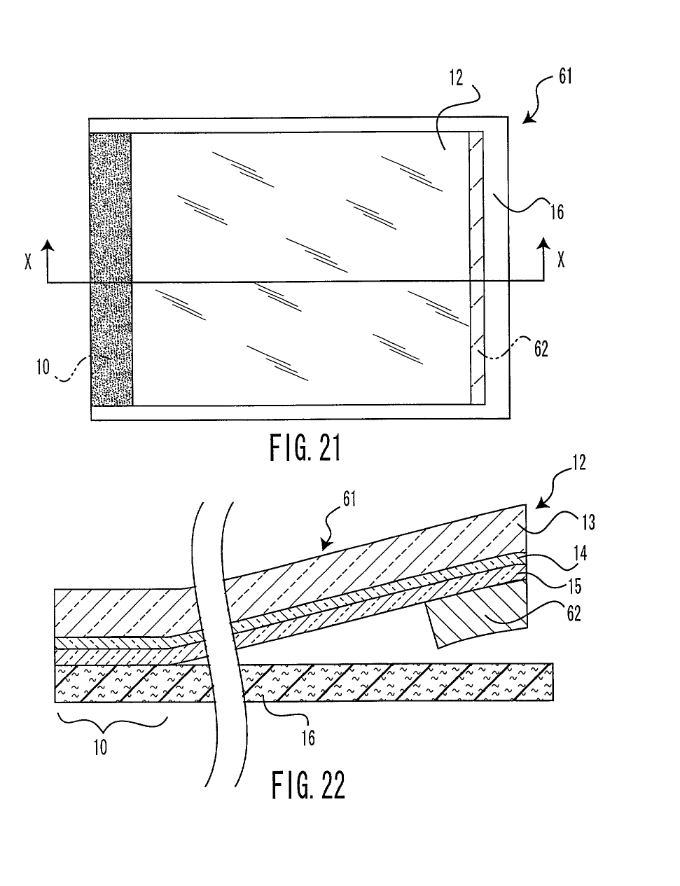

A sixth embodiment according to the present invention will now be described with reference to FIGS. 21 and 22. In this embodiment, the same constituent members as those of the heat-transfer laminating unit 41 according to the fourth embodiment of the present invention mentioned above are denoted by reference numerals designating the same constituent members of this heat-transfer laminating unit 41, thereby omitting the detailed explanation. FIG. 21 is a top plan view showing the heat-transfer laminating unit 61 according to this embodiment. FIG. 22 is a cross-sectional view showing the heat-transfer laminating unit 61 taken along the line X-X in FIG. 21.

The heat-transfer laminating unit 61 according to this embodiment is different from the fourth embodiment in the structure of the non-bonded part. The non-bonded part according to this embodiment is configured to a sheet piece 62 attached to the laminating sheet 12. Specifically, in the laminating sheet 12, the non-bonded part is configured to the sheet piece 62 having no adhesiveness attached to the heat-sensitive adhesive resin layer 15 at the end portion on the opposite side to the bonded part 10.

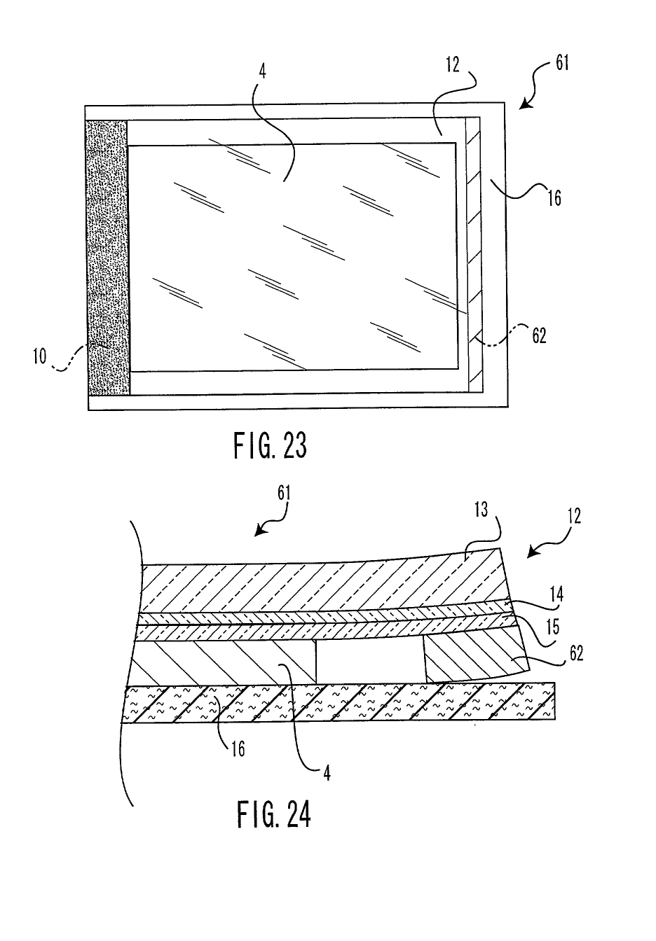

The sheet piece 62 has, for example, a paper material which has no adhesiveness by itself. In addition, as shown in FIG. 23, the sheet piece 62 is bonded on the heat-sensitive adhesive resin layer 15 so as not to be opposed to the coating target sheet 4. That is, the heat-sensitive adhesive resin layer 15 has a part which has been already bonded before carrying out the heat bonding process.

According to this structure, in the heat-transfer laminating unit 61, as shown in FIG. 24, a part to which the sheet piece 62 is bonded is not bonded to the backup sheet 16 even after the heat bonding process. Therefore, the sheet piece 62 can be a trigger for easily exfoliating the separate sheet 13 and the backup sheet 16. Thus, the heat-transfer laminating unit 61 can readily exfoliate the separate sheet 13 after transferring the heat-sensitive adhesive resin layer 15 onto the coating target sheet.

Incidentally, as shown in FIG. 22, although the end portion of the sheet piece 62 according to this embodiment is matched with the end portion of the laminating sheet 12, it may be provided so as to protrude from the end portion of the laminating sheet 12.

Additionally, the sheet piece 62 is not restricted to the arrangement illustrated in this embodiment, and any arrangement can be arbitrarily selected if it can be a trigger for easily exfoliating the separate sheet 13 and the backup sheet 16. It suffices to arranging the sheet piece 62 at least at one part of the end portion of the backup sheet 16.

The sheet piece 62 can be applied to the heat-transfer laminating units 21 and 31 for double-side coating illustrated in FIGS. 10 and 12. In this case, when the sheet piece 62 is bonded to each of the same opposed positions of the first and second laminating sheets 12a and 12b superimposed each other, heat bonding can be prevented, and the separate sheet 13 can be easily exfoliated.

Incidentally, although the sheet piece 62 is configured to one sheet in this embodiment, a plurality of sheets may be arranged at a plurality of positions.

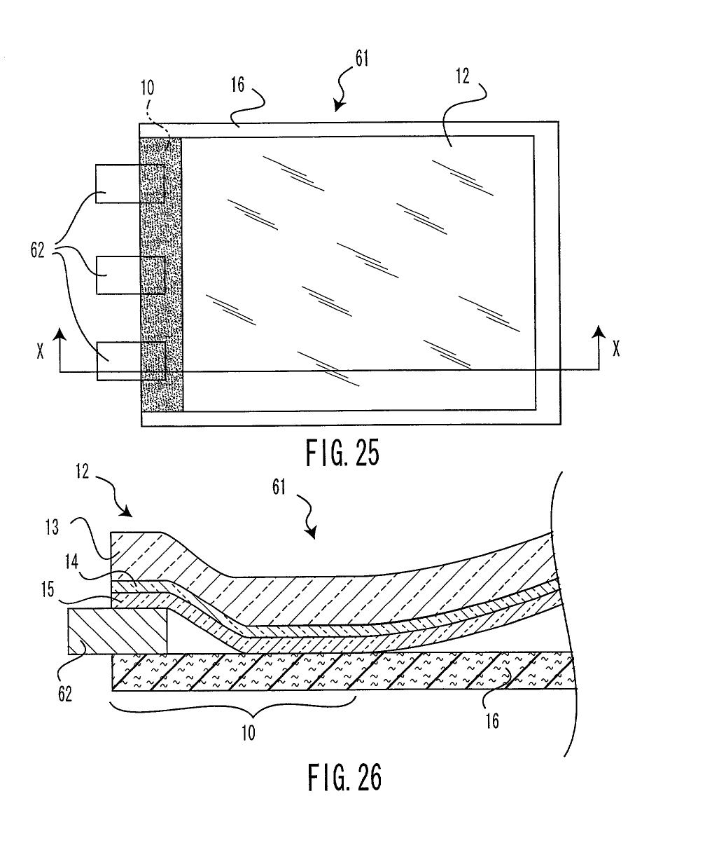

Further, it can be considered that the sheet piece 28 is interposed between, for example, the laminating sheet 12 and the backup sheet 16 at their bonded part 10, as shown in FIGS. 25 and 26. In this case, since the sheet piece 62 can be interposed when bonding the laminating sheet 12 and the backup sheet 16 to each other can suffice, any special process for attaching the sheet piece 62 to the laminating sheet 12 is not required.

(Seventh Embodiment)

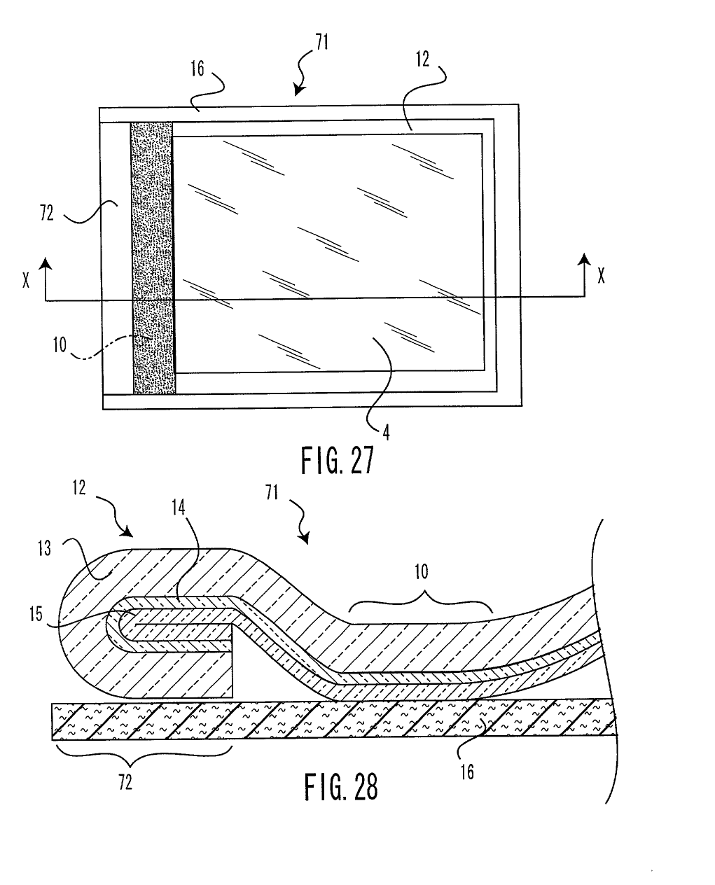

A seventh embodiment according to-the present invention will now be described with reference to FIGS. 27 and 28. In this embodiment, the same constituent members as those of the heat-transfer laminating unit 41 according to the fourth embodiment according to the present invention mentioned above are denoted by reference numerals designating the same constituent members of this heat-transfer laminating unit 41, thereby omitting the detailed explanation. FIG. 27 is a top plan view showing the heat-transfer laminating unit 71 according to this embodiment. FIG. 28 is a cross-sectional view showing the heat-transfer laminating unit 71 taken along the line X-X in FIG. 27.

The heat-transfer laminating unit 71 according to this embodiment is different from the fourth embodiment in the structure of the non-bonded part. The non-bonded part according to this embodiment is configured to bending the laminating sheet 12. Specifically, the non-bonded part is configured to a part 72 of the separate sheet 13 which is formed by bending the end portion of the laminating sheet 12 and at which the heat-sensitive adhesive resin layer 15 is not opposed to the backup sheet 16.

As shown in FIG. 27, the part 72 is arranged with the bonded part 10 interposed between it and the laminating sheet 12. As shown in FIG. 28, that portion of the heat-sensitive adhesive resin layer 15 which lie in the part 72 is bent, consisting of parts heat-bonded to each other.

Therefore, the bent state of the separate sheet 13 can be maintained in the part 72. Accordingly, the heat-sensitive adhesive resin layer 15 has a part which has been already bonded before carrying out the heat bonding process.

According to this structure, in the heat-transfer laminating unit 71, the part 72 is not bonded to the backup sheet 16 even after the heat bonding process. Therefore, the part 72 can be a trigger for easily exfoliating the separate sheet 13 and the backup sheet 16. Thus, the heat-transfer laminating unit 71 can readily exfoliate the separate sheet 13 after transferring the heat-sensitive adhesive resin layer 15 onto the coating target sheet.

Incidentally, although the part 72 is arranged with the bonded part 10 interposed between it and the laminating sheet 12 in this embodiment, it may be formed on the side where the coating target sheet 4 is arranged. That is, the arrangement of the part 72 can be arbitrarily selected if it can be a trigger for easily exfoliating the separate sheet 13 and the backup sheet 16. It suffices to arranging the part 72 at least at one part of the end portion of the backup sheet 16.

(Eighth Embodiment)

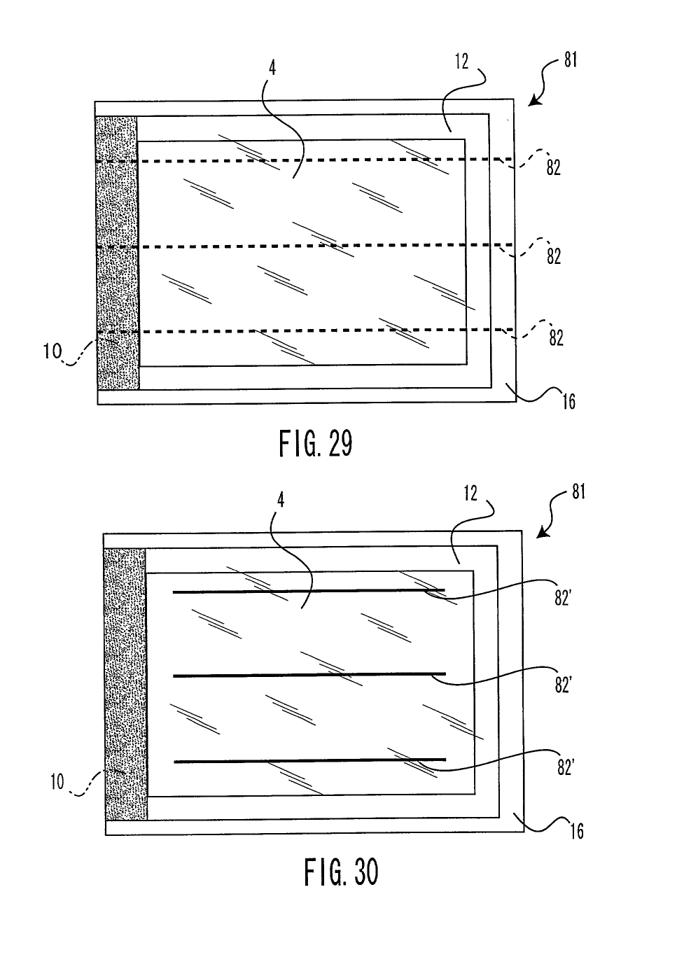

An eighth embodiment according to the present invention will now be described with reference to FIG. 29. In this embodiment, the same constituent members as those of the heat-transfer laminating unit 11 according to the first embodiment of the present invention mentioned above are denoted by reference numerals designating the same constituent members of this heat-transfer laminating unit 11, thereby omitting the detailed explanation. FIG. 29 is a top plan view showing the heat-transfer laminating unit 81 according to this embodiment.

The heat-transfer laminating unit 81 according to this embodiment is different from that according to the first embodiment in that a perforated line 82 is formed to the backup sheet 16. This perforated line 82 is formed at least at a part of the backup sheet 16 opposed to the coating target sheet 4.

One or a plurality of perforated lines 82 is formed so that the backup sheet 16 can be easily torn along the perforated lines 82. Moreover, directions along which the respective perforated lines 82 are formed may be parallel to each other or orthogonal to each other.

When the heat-sensitive adhesive resin layer 15 is thermally transferred onto the coating target sheet 4 by using the heat-transfer laminating unit 81 having such a structure, the laminating sheet 12 and the backup sheet 16 are removed in the following manner.

The backup sheet 16 is torn along the perforated line 82 from the surface of the backup sheet 16 opposed to the coating target sheet 4. Incidentally, since the surface of the backup sheet 16 appressed against the coating target sheet 4 is not bonded to the coating target sheet 4, it can be easily torn. In addition, the backup sheet 16 is torn to the part at which it is bonded to the laminating sheet 12, and the separate sheet 13 is picked and exfoliated.

With the above-described structure, the heat-transfer laminating unit 81 can easily exfoliate the separate sheet 13 after transferring the heat-sensitive adhesive resin layer 15 to the coating target sheet 4.

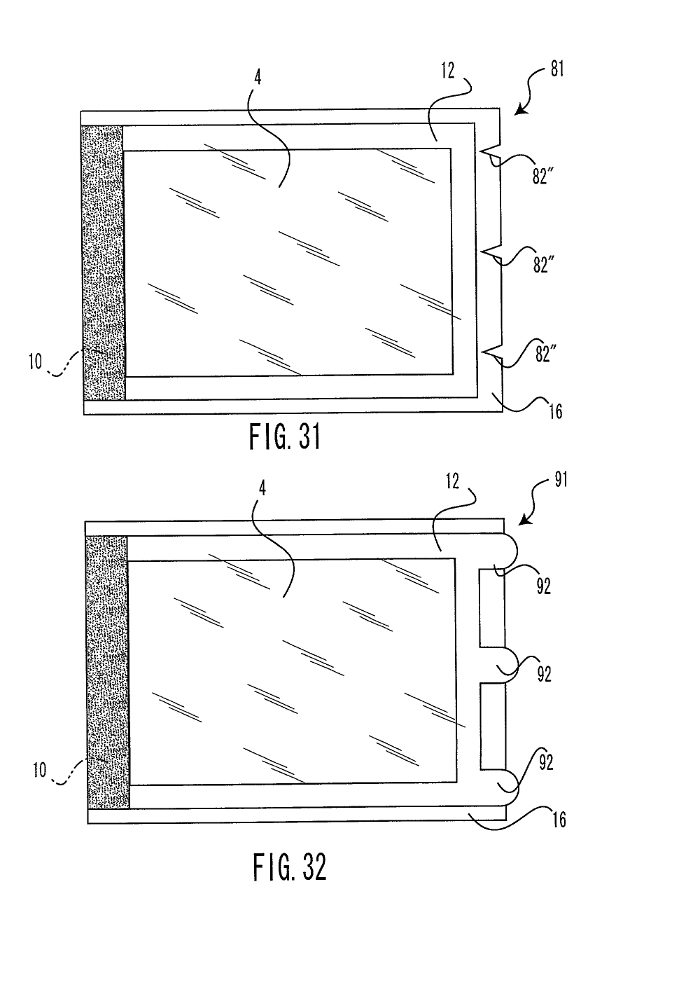

Incidentally, in this embodiment, although the perforated line 82 is formed to the backup sheet 16, any other conformation than the perforated line may be adopted as long as it can facilitate tearing the backup sheet 16 (causing stress concentration for tearing the backup sheet). For example, as shown in FIG. 30, in the heat-transfer laminating unit 81, a cut line 82′ may be formed to the backup sheet 16. Additionally, in the heat-transfer laminating unit 81, as shown in FIG. 31, a cut line 82″ may be formed at a part of the backup sheet 16 which is not opposed to the coating target sheet 4.

(Ninth Embodiment)

A ninth embodiment according to the present invention will now be described with reference to FIG. 32. In this embodiment, the same constituent members as those of the heat-transfer laminating unit according to the fourth embodiment according to the present invention are denoted by reference numerals designating the same constituent members of the heat-transfer laminating unit 41, thereby omitting the detailed explanation. FIG. 32 is a top plan view showing the heat-transfer laminating unit 91 according to this embodiment.

The heat-transfer laminating unit 91 according to this embodiment is different from that of the fourth embodiment in the structure of the non-bonded part. The non-bonded part according to this embodiment is configured to a protrusion portion 92 of the laminating sheet 12 extending beyond the backup sheet. Specifically, the non-bonded part is configured to three protrusion portions 92 which protrude from the end portion of the laminating sheet 12 on the opposite side to the bonded part 10.

Although each protrusion portion 92 is formed so as to protrude from the backup sheet 16 toward the outside by approximately 1 mm, its protruding region is small, and a length protruding toward the outside is short. Therefore, in each protrusion portion 92, the heat-sensitive adhesive resin layer 15 does not come into contact with a pair of the rollers 6000 in the heat bonding process. Thus, the laminating apparatus 5000 is prevented from being fouled by the heat-sensitive adhesive resin layer 15.

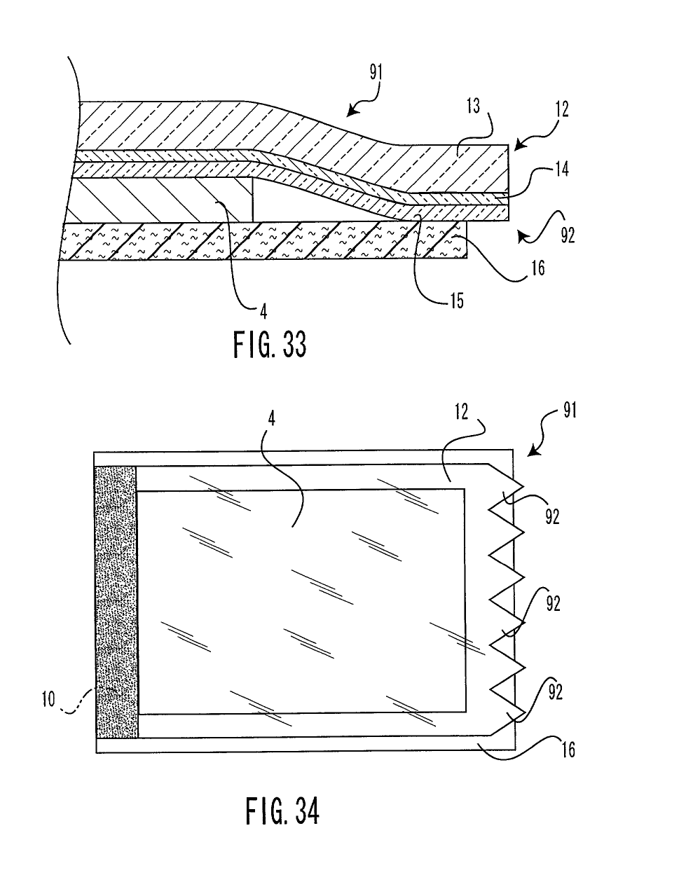

According to this structure, in the heat-transfer laminating unit 91, the protrusion portion 92 is not bonded to the backup sheet 16 even after the heat bonding process as shown in FIG. 33. Therefore, the protrusion portion 92 can be a trigger for easily exfoliating the separate sheet 13 and the backup sheet 16. Accordingly, the heat-transfer laminating unit 91 can readily exfoliate the separate sheet 13 after transferring the heat-sensitive adhesive resin layer 15 onto the coating target sheet 4.

Incidentally, the dimension of the protrusion portion 92 protruding from the backup sheet 16 toward the outside is not restricted as long as it is such a value that the heat-sensitive adhesive resin layer 15 does not come into contact with a pair of the rollers 6000 in the heat bonding process. In this connection, although the dimension that the heat-sensitive adhesive resin layer 15 is not brought into contact with a pair of the rollers 6000 is affected by the thickness of the backup sheet 16, it is preferable that the dimension is usually set to be larger than 0 mm and not more than approximately 1 mm. The dimension is preferably set to 0.5 mm when taking notice of contact with a pair of the rollers 6000 in particular, and it is preferably set to approximately 1 mm when taking notice of easiness of grabbing in particular.

Further, the shape of the protrusion portion 92 is not restricted to a semicircle mentioned above, and such a triangular shape as shown in FIG. 34 may be adopted for example. The protrusion portion 92 is not restricted to specific shapes. The laminating sheet 12 is cut into two parts, each having an edge which has triangular shapes. Both parts can be utilized as laminating sheets 12. This is advantageous for the manufacturing cost.

Furthermore, although three protrusion portions 92 are formed in this embodiment, the protrusion portion 92 is not restricted to any number if it can be a trigger for easily exfoliating the separate sheet 13 and the backup sheet 16.

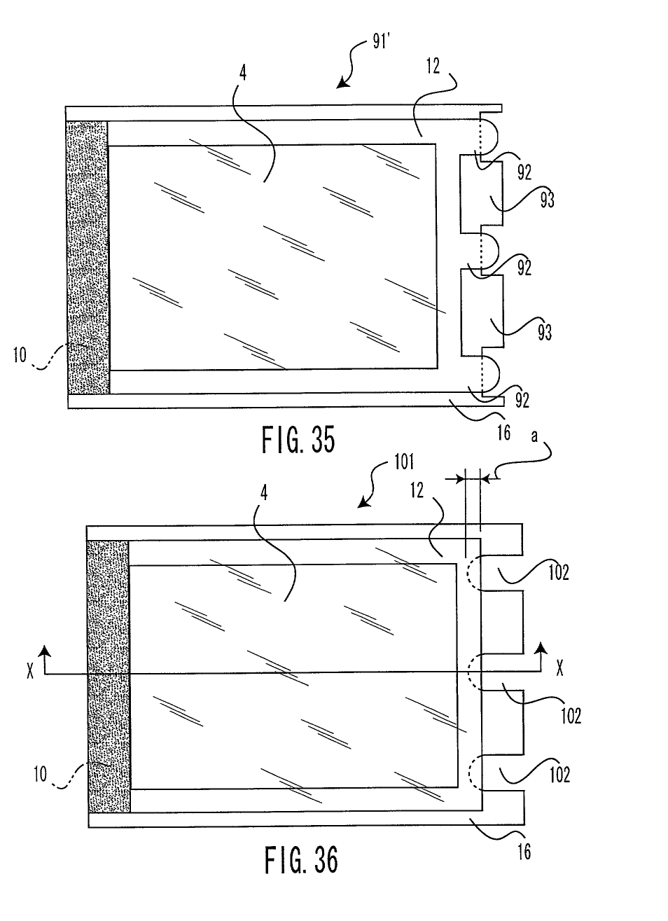

Moreover, in the heat-transfer laminating unit 91′ shown in FIG. 35 as a modification of this embodiment, protrusion portions 93 are provided to the backup sheet 16 so as to be positioned between the respective protrusion portions 92. That is, in the heat-transfer laminating unit 91′, the respective protrusion portions 92 and 93 are formed to the laminating sheet 12 and the backup sheet 16, and the protrusion portions 92 and 93 are alternately arranged.

By configuring in this manner, the protrusion portion 92 of the laminating sheet 12 can be prevented from coming into contact with the roller surfaces of a pair of the rollers 6000 by the protrusion portion 93 of the backup sheet 16 in the heat bonding process. That is, if the backup sheet 16 exists on the periphery of the protrusion portion 92, a gap between the roller surfaces of a pair of the rollers 6000 and the heat-sensitive adhesive resin layer 15 can be maintained constant by the thickness of the backup sheet 16 in the heat bonding process. Therefore, the heat-sensitive adhesive resin layer 15 of the protrusion portion 92 can be prevented from coming into contact with the roller surfaces of a pair of the rollers 6000.

(Tenth Embodiment)

A tenth embodiment according to the present invention will now be described with reference to FIG. 36. In this embodiment, the same constituent members as those of the heat-transfer laminating unit according to the ninth embodiment of the present invention mentioned above are denoted by reference numerals designating the same constituent members of this heat-transfer laminating unit 91, thereby omitting the detailed explanation. FIG. 36 is a top plan view showing the heat-transfer laminating unit 101 according to this embodiment.

The heat-transfer laminating unit 101 according to this embodiment is different from that of the ninth-embodiment in the structure of the non-bonded part. The non-bonded part according to this embodiment is configured to a notch portion 102 of the backup sheet. Specifically, the non-bonded part is configured to three notch portions 102 which are notches formed from the end portion of the backup sheet on the opposite side to the bonded part 10 toward the laminating sheet side (inner side).

The notch portion 102 has a semicircular shape. The tip of the notch portion 102 on the inner side is extended to the position opposed to the laminating sheet 12. The notch dimension at the position opposed to the laminate is set so that the heat-sensitive adhesive resin layer 15 does not come into contact with a pair of the rollers 6000 in the heat bonding process, as similar to the dimension described in connection with the ninth embodiment. Therefore, the backup sheet 16 exists on the periphery of the notch portion 102. Accordingly, the gap between the roller surfaces of a pair of the rollers 6000 and the heat-sensitive adhesive resin layer 15 is maintained constant by the thickness of the backup sheet 16 in the heat bonding process. As a result, the heat-sensitive adhesive resin layer 15 positioned at the notch portion 102 is prevented from coming into contact with the roller surfaces of a pair of the rollers 6000 even if it is passed through a pair of the rollers 6000. The dimension a of the semicircular shape is set to approximately 1 mm in this embodiment.

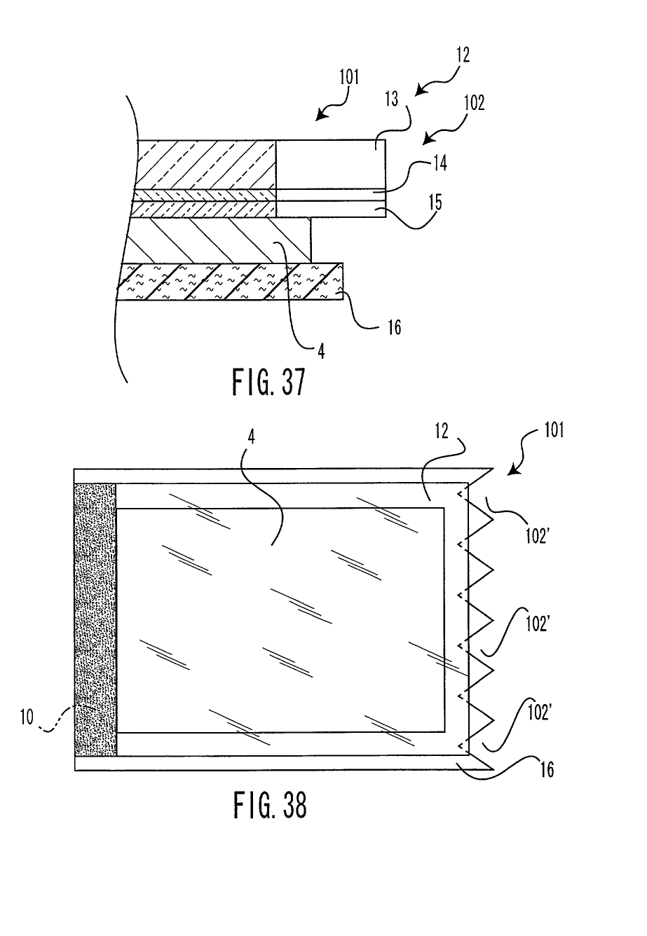

According to this structure, in this heat-transfer laminating unit 101, the part of the separate sheet 13 corresponding to the notch portion 102 is not bonded to the backup sheet 16 even after the heat bonding process as shown in FIG. 37. Therefore, the notch portion 102 can be a trigger for easily exfoliating the separate sheet 13 and the backup sheet 16. Thus, the heat-transfer laminating unit 101 can readily exfoliate the separate sheet 13 after transferring the heat-sensitive adhesive resin layer 15 onto the coating target sheet 4.

Incidentally, the shape of the notch portion 102 is not restricted to the semicircular shape mentioned above. For example, a triangular notch 102′ such as shown in FIG. 38 may be adopted, and the notch portion 102 is not restricted to specific shapes.

(11th Embodiment)

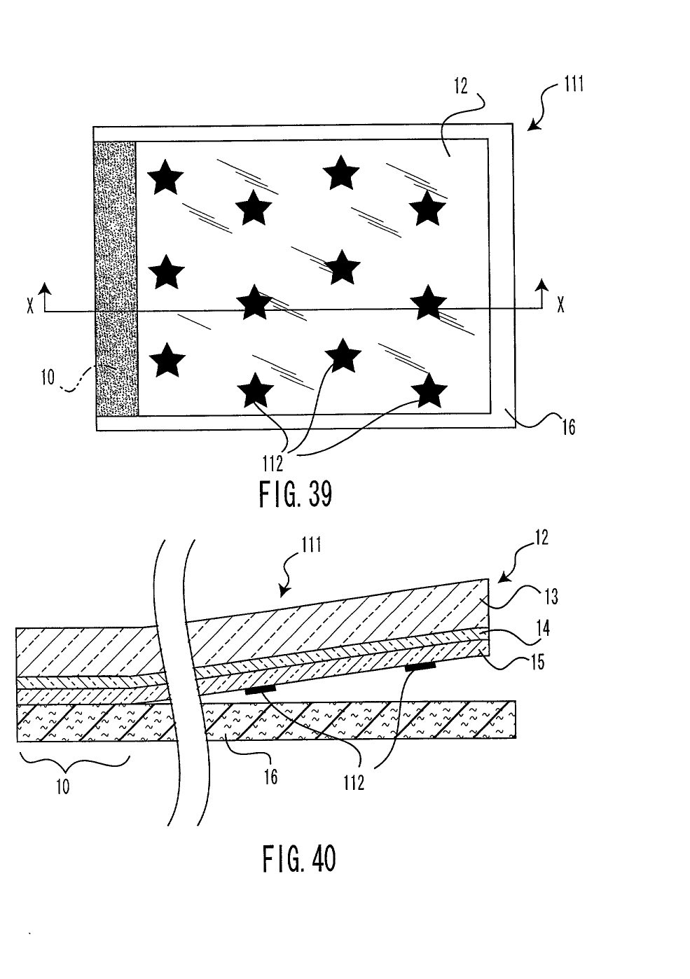

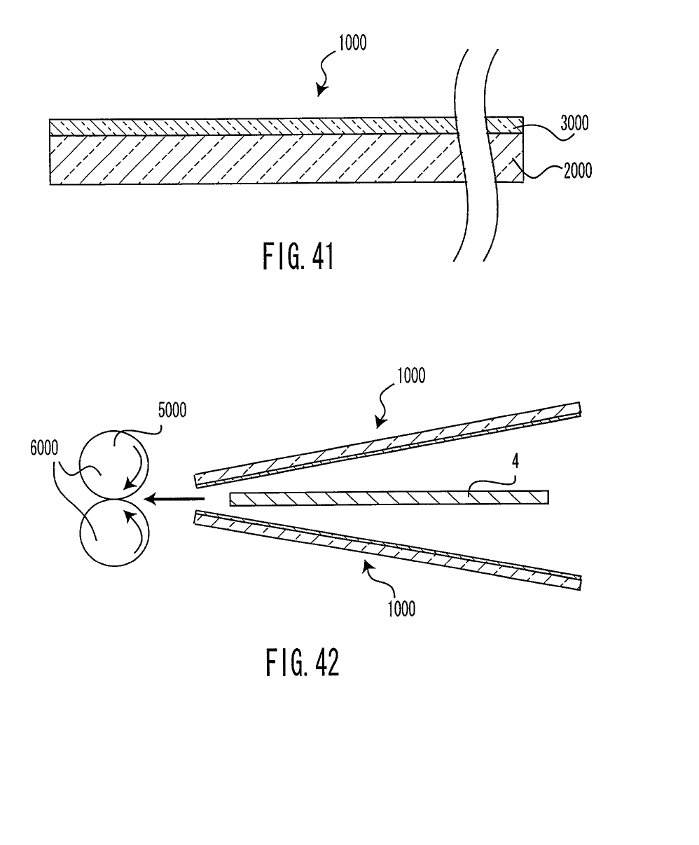

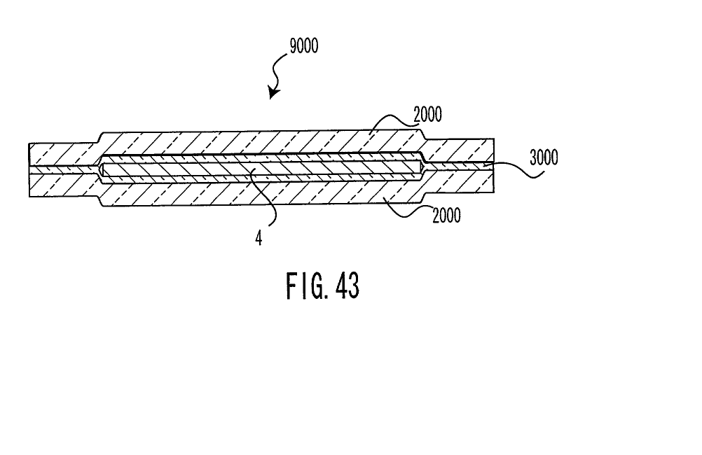

An 11th embodiment according to the present invention will now be described with reference to FIGS. 39 and 40. In this embodiment, the same constituent members as those of the heat-transfer laminating unit 11 according to the first embodiment of the present invention mentioned above are denoted by reference numerals designating the same constituent members of this heat-transfer laminating unit 91, thereby omitting the detailed explanation. FIG. 39 is a top plan view showing the heat-transfer laminating unit 11 according to this embodiment. FIG. 40 is a cross-sectional view showing the heat-transfer laminating unit 11 taken along the line X-X in FIG. 39.

The heat-transfer laminating unit 111 partially has a picture (pattern) 112 on the transparent heat-sensitive adhesive resin layer 15 having the water resistance.

The picture 112 can be an image having a color which is not reproduced by an ink of an ink jet printer, e.g., a metallic color such as gold or silver, or a fluorescent ink image which is excited and emits light by ultraviolet light rays. Moreover, as the picture 112, a design, a pattern, a character or the like which is scattered on the entire laminating sheet 12 is preferable. These pictures are superimposed on an image which is previously formed by ink jet printing or the like on the coating target sheet 4, which brings the excellent design effect.

In addition, according to this embodiment, since the backup sheet 16 can accept not only the heat-sensitive adhesive resin layer 15 but also the picture 80, there is an advantage that the laminating apparatus 5000 can be further prevented from being fouled.

Additionally, the picture 112 can be uniformly arranged on the entire laminating sheet 112. That is, the laminating sheet 12 can be configured in a color film form.

Although the above has concretely described several embodiments with reference to the accompanying drawings, the present invention is not restricted to these embodiments but includes all embodiments carried out without departing from the scope of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A heat-transfer laminating unit comprising:
a laminating sheet shaped like a cut sheet and comprising a separate sheet and a heat-sensitive adhesive layer provided on the separate sheet and configured to be separated from the separate sheet; and
a backup sheet as large as the laminating sheet, at a minimum size, and opposing the heat-sensitive adhesive layer of the laminating sheet,
wherein the laminating sheet and the backup sheet are bonded to each other at one part and not bonded at the other part.

2. The heat-transfer laminating unit according to claim 1, wherein the backup sheet is a sheet not adhesive.

3. The heat-transfer laminating unit according to claim 2, wherein the backup sheet comprises a paper sheet.

4. The heat-transfer laminating unit according to claim 1, wherein the backup sheet comprises a separating layer on one surface.

5. The heat-transfer laminating unit according to claim 1, wherein the backup sheet has an index on one surface, said index facilitating positioning of a sheet to be covered.

6. The heat-transfer laminating unit according to claim 1, wherein the laminating sheet and the backup sheet are bonded to each other by means of heat bonding.

7. The heat-transfer laminating unit according to claim 1, wherein the backup sheet and the backup sheet are bonded to each other by means of pressure-sensitive adhesion.

8. The heat-transfer laminating unit according to claim 7, wherein the pressure-sensitive adhesion is achieved by use of a double-coated tape.

9. The heat-transfer laminating unit according to claim 7, wherein the pressure-sensitive adhesion is achieved by use of adhesive.

10. The heat-transfer laminating unit according to claim 1, wherein the laminating sheet and the backup sheet are perforated along a border between said one part and said other part.

11. The heat-transfer laminating unit according to claim 1, wherein the laminating sheet and the backup sheet have a groove along a border between said one part and said other part, said groove having been made by embossing.

12. The heat-transfer laminating unit according to claim 1, wherein at least one of the laminating sheet and backup sheet has a non-bonded part at one end, which facilitates separation of the laminating sheet and the backup sheet after heat transfer has been accomplished.

13. The heat-transfer laminating unit according to claim 12, wherein the non-bonded part is a part of the backup sheet, to which no adhesive has been applied.

14. The heat-transfer laminating unit according to claim 12, wherein the non-bonded part is an end part of the laminating sheet, on which the heat-sensitive adhesive layer is not provided.

15. The heat-transfer laminating unit according to claim 12, wherein the non-bonded part is a piece of a non-adhesive sheet.

16. The heat-transfer laminating unit according to claim 15, wherein the piece of a non-adhesive sheet is interposed between said one part of the laminating sheet and said one part of the backup sheet.

17. The heat-transfer laminating unit according to claim 1, wherein the backup sheet has a notch.

18. The heat-transfer laminating unit according to claim 1, wherein the laminating sheet has a folded part at end, the folded part having two parts of the heat-sensitive adhesive layer which oppose each other.

19. The heat-transfer laminating unit according to claim 1, wherein the laminating sheet has a part projecting from the backup sheet.

20. The heat-transfer laminating unit according to claim 1, wherein the backup sheet has a notch made in at least one end part that overlaps the laminating sheet.

21. A heat-transfer laminating unit comprising:
a first laminating sheet comprising a separate sheet and a heat-sensitive adhesive layer provided on the separate sheet and configured to be separated from the separate sheet; and
a second laminating sheet of the same structure and substantially the same size as the first laminating sheet, having a heat-sensitive adhesive layer which opposes the heat-sensitive adhesive layer of the first laminating sheet,
wherein the first and second laminating sheets are shaped like a cut sheet and are bonded to each other at one part and not bonded at the other part.

22. The heat-transfer laminating unit according to claim 21, further comprising a non-adhesive sheet interposed between the first and second laminating sheets.

23. The heat-transfer laminating unit according to claim 21, wherein the first and second laminating sheets are provided by folding one laminating sheet.

24. The heat-transfer laminating unit according to claim 1, wherein the heat-sensitive adhesive layers have a pattern printed on at least one part.
